(19) United States
(12) Patent Application Publication
(10) Pub. No.: US 2011/0115413 A1
(43) Pub. Date: May 19, 2011

(54) CONFIGURING AND CONTROLLING CASINO MULTIMEDIA CONTENT SHOWS

(75) Inventors: Eric V. Erickson, Mt Prospect, IL (US); John L. Griffin, Chicago, IL (US); Timothy T. Gronkowski, Chicago, IL (US); Sean P. Kelly, Skokie, IL (US); David M. Pryor, Elmhurst, IL (US); Alfred Thomas, Las Vegas, NV (US); Martin R. Ugarte, JR., Chicago, IL (US)

(73) Assignee: WMS Gaming, Inc., Waukegan, IL (US)

(21) Appl. No.: 12/945,443

(22) Filed: Nov. 12, 2010

Related U.S. Application Data
(60) Provisional application No. 61/261,308, filed on Nov. 14, 2009.

(51) Int. Cl. H05B 37/00

(52) U.S. Cl. 315/312

(57) ABSTRACT

A wagering game system and its operations are described herein. In some embodiments, the operations can include configuring a casino light show on a light show design map using lighting device objects that correlate to lighting hardware devices in a casino. The lighting hardware devices can present light effects using different lighting control formats. The operations can further include configuring the light effects for the lighting device objects, and generating lighting control instructions in a common data format. The operations can further include converting the lighting control instructions to individual sets of lighting control instructions that comply with the different lighting control formats. The operations can further use the sets of lighting control instructions to present the light effects on the lighting hardware devices according to the different lighting control formats required by the lighting hardware devices.

### RELATED APPLICATIONS

This application claims the priority benefit of U.S. Provisional Application Ser. No. 61/261,308 filed Nov. 14, 2009.

### LIMITED COPYRIGHT WAIVER

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2010, WMS Gaming, Inc.

### TECHNICAL FIELD

Embodiments of the inventive subject matter relate generally to wagering game systems and networks that, more particularly, configuring and controlling casino multimedia content shows.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play. Further, environmental effects that surround a wagering game machine are useful for engaging a player's attention and immersing the player in the gaming experience. Therefore, there is also a continuing need for wagering game manufacturers to develop new and interesting environmental effects that integrate with gaming activity.

### BRIEF DESCRIPTION OF THE DRAWING(S)

Embodiments are illustrated in the Figures of the accompanying drawings in which:

FIG. 1 is an illustration of configuring a casino light show using lighting device objects with multiple lighting control formats and controlling multiple lighting hardware devices using configuration data, according to some embodiments;

FIG. 2 is an illustration of a wagering game system architecture 200, according to some embodiments;

FIG. 3 is a flow diagram 300 illustrating configuring a light show using configurable lighting device objects and configurable timelines, according to some synchronized light show control data embodiments;

FIG. 4 is an illustration of configuring a light show using a configuration tool having configurable lighting device objects and configurable timelines, according to some embodiments;

FIG. 5 is an illustration of configuring casino light shows using a configuration tool having configurable light timing pattern graphics that represent light show timelines, according to some embodiments;

FIG. 6 is a flow diagram 600 illustrating receiving show control data in a common data format, converting the common data to hardware specific lighting control instructions for lighting hardware devices that utilize different lighting control formats, and controlling the lighting hardware devices using converted lighting control instructions, according to some embodiments;

FIG. 7 is an illustration of a wagering game machine architecture 700, according to some embodiments;

FIG. 8 is an illustration of a mobile wagering game machine 800, according to some embodiments; and

FIG. 9 is an illustration of a wagering game machine 900, according to some embodiments.

### DESCRIPTION OF ILLUSTRATIVE EMBODIMENTS

This description of the embodiments is divided into five sections. The first section provides an introduction to embodiments. The second section describes example operating environments while the third section describes example operations performed by some embodiments. The fourth section describes additional example operating environments while the fifth section presents some general comments.

### Introduction

This section provides an introduction to some embodiments.

Wagering games are expanding in popularity. Many wagering game enthusiasts are demanding greater access to wagering games and content related to wagering games. Wagering game providers are constantly in need of concepts that can make the gaming industry appealing and profitable. Some wagering game providers have attempted to enhance the wagering game experience by implementing sound and light shows within a casino. Environmental sound and light effects within a casino immerse a wagering game player (“player”) in the gaming experience by stimulating the player's senses. Thus, the casino's stimulating environment can greatly enhance the player's experience within the casino, which can lead to greater customer loyalty for the casino. Thus, wagering game providers and casino operators are both interested in new and interesting concepts involving environmental immersion of the player in the gaming experience within a casino, such as via casino light shows.

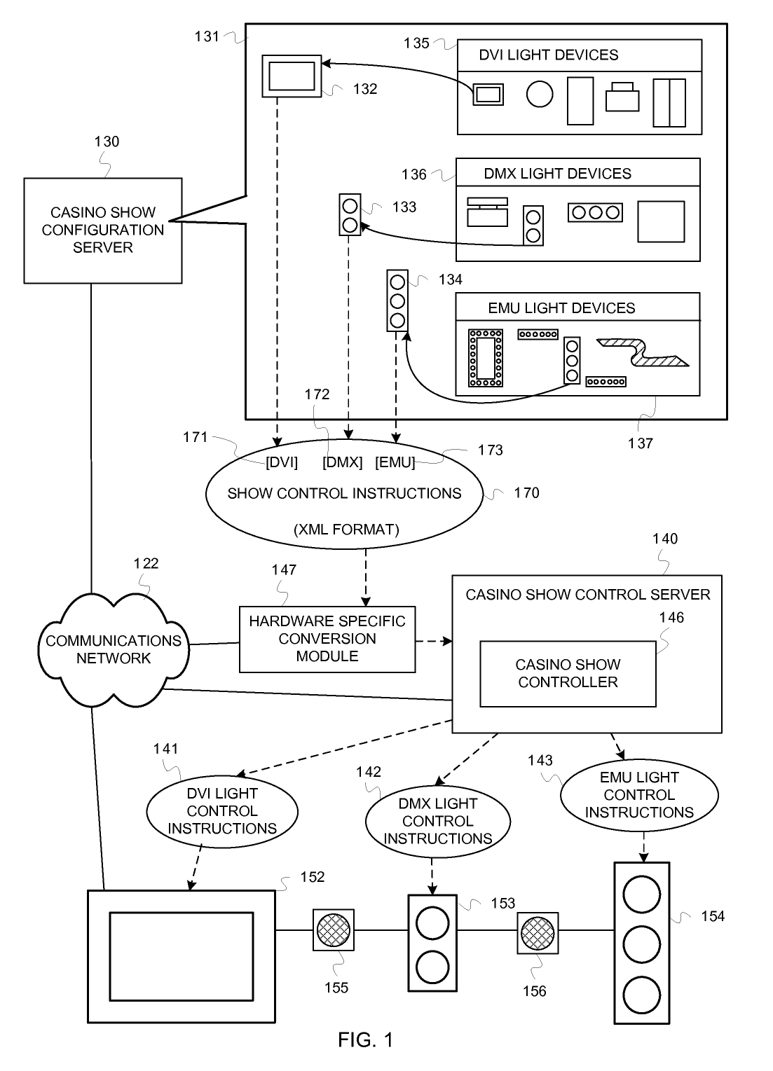

FIG. 1 is a conceptual diagram that illustrates an example of configuring a casino light show using lighting device objects with multiple lighting control formats and controlling multiple lighting hardware devices using configuration data, according to some embodiments. In FIG. 1, a wagering game system (“system”) 100 includes a casino show configuration server (“show configuration server”) 130 connected to a casino show control server (“show control server”) 140, lighting hardware devices (“lighting devices”) 152, 153 and 154 and sound hardware devices (“sound devices”) 155 and 156 connected via a communications network 122. Any one, or all, of the lighting devices 152, 153, and 154, and/or the sound devices 155 and 156 can be associated with wagering game machines, wagering game servers, lighting servers, sound servers, or any other device or machine on a casino network. The show control server 140 can control light and sound effects that originate, respectively, from the lighting devices 155, 153, 154 and the sound devices 155 and 156. The light and sound effects can be associated with synchronized multi-media casino content shows (“casino shows”), which can include light effects, sound effects, fog effects, etc. The casino shows can be triggered by gaming events, such as jackpot wins, major player accomplishments, etc. The gaming events can be accomplished by, or associated with, a wagering game player account (“player account”). A wagering game player (“player”) can log in to the player account to engage in a wagering game session at a wagering game machine. A wagering game server can provide gaming content to the wagering game machine and/or the wagering game machine can store and control its own content. The wagering game machine can present the gaming content to the player associated with the player account. During the wagering game session the player can make wagers and win or lose amounts of cash, credits, or other form of money. When a player wins a game, the system 100 may play a casino show on the lighting devices 152, 153, 154 and/or sound devices 155 and 156 to highlight the player's accomplishments. In yet other embodiments, the system 100 may play casino shows to market games, casino events, etc.

The show configuration server 130 can configure casino shows ahead of time and generate show control instructions for the lighting devices 152, 153, and 154, and/or the sound devices 155 and 156. As an example, the show configuration server 130 can present a casino show configuration user interface (“configuration interface”) 131 that includes several lighting device consoles 135, 136, and 137. Each of the lighting device consoles 135, 136, and 137 can include sets of objects that represent different types of lighting devices that utilize different lighting control formats. For example, lighting device console 135 can present lighting device objects (e.g., display device object 132) that require the digital visual interface (DVI) standard for presenting lighting effects. The display device object 132 represents a real world, hardware display device (i.e., the display device 152) that requires the DVI format. In another example, lighting device console 136 can present DMX512 (DMX) lighting device objects, such as a spot light device object 133. The spot light device object 133 represents a real world, hardware spot light device (i.e., spot light device 153) that requires a DMX control format. Furthermore, in another example, lighting device console 137 can present proprietary emotive lighting device objects, such as an emotive lighting device object 134. The emotive lighting device object 134 represents a real-world emotive lighting device (i.e., emotive lighting device 154) that requires a proprietary emotive lighting control format (i.e., an “EMU” lighting control format).

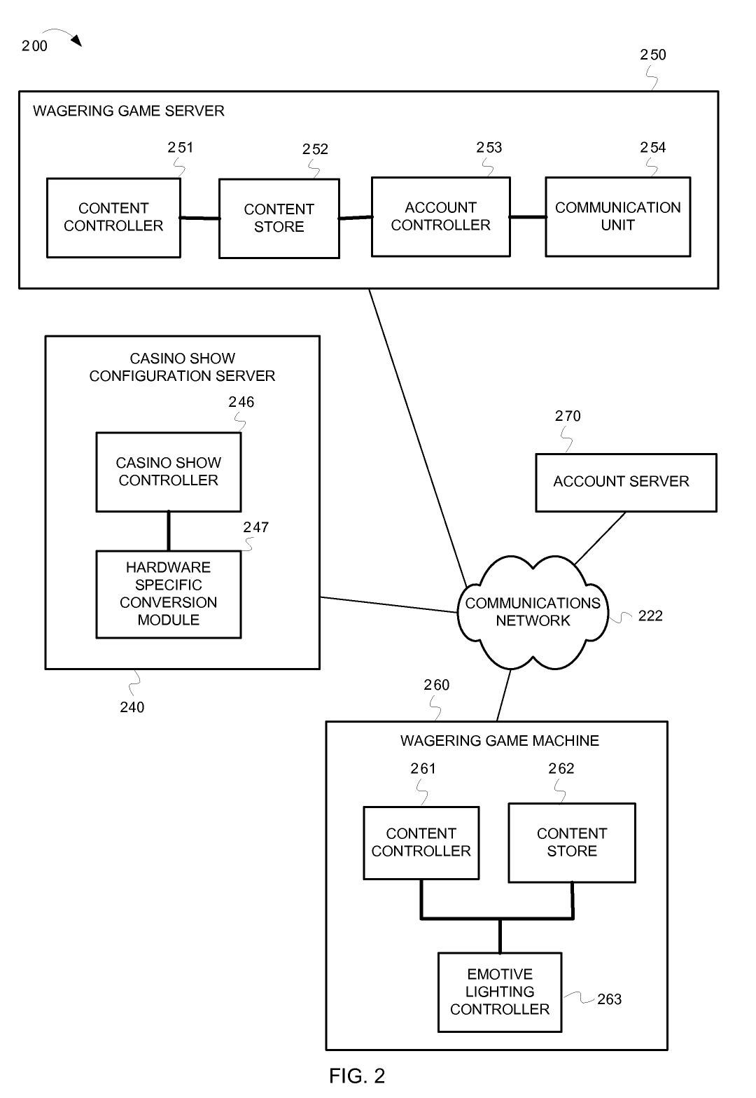

The show configuration server 130 generates a set of casino show control instructions (“control instructions”) 170 in a common output format (e.g., an XML format). The show configuration server 130 can send the control instructions 170 to a hardware specific conversion module 147 that receives the control instructions 170, and converts the control instructions 170 into lighting control instructions that comply with the required lighting control formats required by each individual presentation device (e.g., converts the control instructions 170 into a set of DVI light control instructions 141, a set of DMX light control instructions 142, and set of EMU light control instructions 143). The hardware specific conversion module 147 can convert the common format (e.g., the XML format) of the control instructions 170 to the individual lighting control formats (e.g., DVI, DMX, and EMU formats) required respectively by the display device 152, the spot light device 153, and the emotive lighting device 154. In some embodiments, the hardware specific conversion module 147 can be included in the show configuration server 130. In other embodiments, however, the hardware specific conversion module 147 may be in another network location separate from the show configuration server 130, such as in a show control server 140. The show control server 140 can include a casino show controller 146 that uses the converted control instructions (e.g., the set of DVI light control instructions 141, the set of DMX light control instructions 142, and the set of EMU light control instructions 143) to control sets, or sequences, of light effects on the lighting devices (e.g., the display device 152, the spot light device 153, and the emotive lighting device 154) according to a common, or shared, time schedule for a casino light show. In some embodiments, the show control server 140 can use the convert control instructions to present sound on the sound devices 155 and 156, such as by using DMX light control instructions to control sound devices. Further, it should be noted that the casino show controller 146 can be included in the show configuration server 130 instead of, or in addition to, the show control server 140 (for example, see FIG. 2). In other words, in some embodiments, the show configuration server 130 can configure, convert, and present casino shows, such as to preview the shows on the various lighting devices (e.g., the display device 152, the spot light device 153, and the emotive lighting device 154) using converted (i.e., hardware specific) lighting control instructions.

According to some embodiments, the wagering game system 100 can include numerous capabilities and configurations. However, although FIG. 1 describes some embodiments, the following sections describe many other features and embodiments.

Further, some embodiments of the inventive subject matter describe examples of configuring and controlling casino multimedia content shows using a communication network, such as the communications network 122 in FIG. 1. Embodiments can be presented over any type of communications network that provides access to wagering games, such as a public network (e.g., a public wide-area-network, such as the Internet), a private network (e.g., a private local-area-network gaming network), a file sharing network, a social network, etc., or any combination of networks. Multiple users can be connected to the networks via computing devices. The multiple users can have accounts that subscribe to specific services, such as account-based wagering systems (e.g., account-based wagering game websites, account-based casino networks, etc.).

In some embodiments herein a user may be referred to as a player (i.e., of wagering games), and a player may be referred to interchangeably as a player account. Account-based wagering systems utilize player accounts when transacting and performing activities, at the computer level, that are initiated by players. Therefore, a “player account” represents the player at a computerized level. The player account can perform actions via computerized instructions. For example, in some embodiments, a player account may be referred to as performing an action, controlling an item, communicating information, etc. Although a player, or person, may be activating a game control or device to perform the action, control the item, communicate the information, etc., the player account, at the computer level, can be associated with the player, and therefore any actions associated with the player can also be associated with the player account. Therefore, for brevity, to avoid having to describe the interconnection between player and player account in every instance, a “player account” may be referred to herein in either context. Further, in some embodiments herein, the word “gaming” is used interchangeably with “gambling.”

### Example Operating Environments

This section describes example operating environments and networks and presents structural aspects of some embodiments. More specifically, this section includes discussion about wagering game system architectures.

### Wagering Game System Architecture

FIG. 2 is a conceptual diagram that illustrates an example of a wagering game system architecture 200, according to some embodiments. The wagering game system architecture 200 can include an account server 270 configured to control user related accounts accessible via wagering game networks and social networking networks. The account server 270 can store wagering game player account information, such as account settings (e.g., settings related to group games, etc., settings related to social contacts, etc.), preferences (e.g., player preferences regarding casino multimedia content shows, player preferences regarding light colors, player preferences regarding music, etc.), player profile data (e.g., name, avatar, screen name, etc.), and other information for a player's account (e.g., financial information, account identification numbers, virtual assets, social contact information, etc.). The account server 270 can contain lists of social contacts referenced by a player account. The account server 270 can also provide auditing capabilities, according to regulatory rules. The account server 270 can also track performance of players, machines, and servers.

The wagering game system architecture 200 can also include a wagering game server 250 configured to control wagering game content, provide random numbers, and communicate wagering game information, account information, and other information to and from the wagering game machine 260. The wagering game server 250 can include a content controller 251 configured to manage and control content for the presentation of content on the wagering game machine 260. For example, the content controller 251 can generate game results (e.g., win/loss values), including win amounts, for games played on the wagering game machine 260. The content controller 251 can communicate the game results to the wagering game machine 260. The content controller 251 can also generate random numbers and provide them to the wagering game machine 260 so that the wagering game machine 260 can generate game results. The wagering game server 250 can also include a content store 252 configured to contain content to present on the wagering game machine 260. The wagering game server 250 can also include an account manager 253 configured to control information related to player accounts. For example, the account manager 253 can communicate wager amounts, game results amounts (e.g., win amounts), bonus game amounts, etc., to the account server 270. The wagering game server 250 can also include a communication unit 254 configured to communicate information to the wagering game machine 260 and to communicate with other systems, devices and networks.

The wagering game system architecture 200 can also include a wagering game machine 260 configured to present wagering games and receive and transmit information to configuring and controlling casino multimedia content shows. The wagering game machine 260 can include a content controller 261 configured to manage and control content and presentation of content on the wagering game machine 260. The wagering game machine 260 can also include a content store 262 configured to contain content to present on the wagering game machine 260. The wagering game machine 260 can also include an emotive lighting controller 263 configured to configured to control communications including emotive light presentation data. In some embodiments, the emotive lighting controller 263 can be external to the wagering game machine 260, such as attached to a cabinet associated with the wagering game machine 260. In other embodiments, the emotive lighting controller 263 can be detached from the wagering game machine 260 and can be a separate device that controls emotive lighting devices assigned to, proximate to, or in other ways associated with the wagering game machine 260.

The wagering game system architecture 200 can also include a casino show configuration server 230 configured to configure casino shows, including light shows. The casino show configuration server 230 can include a casino show configuration module 231 configured to provide a platform and/or protocol agnostic configuration functionality that an operator can use to configure settings for a casino show, such as a casino light show.

The wagering game system architecture 200 can also include a casino show control server 240 configured to control casino shows. The casino show control server 240 can include a casino show controller 246 configured to control presentation of a casino show, including presentation of light effects and sound effects tied to pre-configured light and sound show instructions. The casino show control server 240 can also include a hardware specific conversion module 247 configured to convert light show instructions to required lighting control formats for lighting hardware devices on a casino network.

Each component shown in the wagering game system architecture 200 is shown as a separate and distinct element connected via a communications network 222. However, some functions performed by one component could be performed by other components. For example, the wagering game server 250 can also be configured to perform functions of the emotive lighting controller 263, and other network elements and/or system devices. Furthermore, the components shown may all be contained in one device, but some, or all, may be included in, or performed by, multiple devices, as in the configurations shown in FIG. 2 or other configurations not shown. For example, the account manager 253 and the communication unit 254 can be included in the wagering game machine 260 instead of, or in addition to, being a part of the wagering game server 250. Further, in some embodiments, the wagering game machine 260 can determine wagering game outcomes, generate random numbers, etc. instead of, or in addition to, the wagering game server 250. Further, in some embodiments, the casino show configuration module 231, casino show controller 242, and the hardware specific conversion module 247 can be combined in one device or into one module (e.g., a casino show module).

The wagering game machines described herein (e.g., wagering game machine 260) can take any suitable form, such as floor standing models, handheld mobile units, bar-top models, workstation-type console models, surface computing machines, etc. Further, wagering game machines can be primarily dedicated for use in conducting wagering games, or can include non-dedicated devices, such as mobile phones, personal digital assistants, personal computers, etc.

In some embodiments, wagering game machines and wagering game servers work together such that wagering game machines can be operated as thin, thick, or intermediate clients. For example, one or more elements of game play may be controlled by the wagering game machines (client) or the wagering game servers (server). Game play elements can include executable game code, lookup tables, configuration files, game outcome, audio or visual representations of the game, game assets or the like. In a thin-client example, the wagering game server can perform functions such as determining game outcome or managing assets, while the wagering game machines can present a graphical representation of such outcome or asset modification to the user (e.g., player). In a thick-client example, the wagering game machines can determine game outcomes and communicate the outcomes to the wagering game server for recording or managing a player's account.

In some embodiments, either the wagering game machines (client) or the wagering game server(s) can provide functionality that is not directly related to game play. For example, account transactions and account rules may be managed centrally (e.g., by the wagering game server(s)) or locally (e.g., by the wagering game machines). Other functionality not directly related to game play may include power management, presentation of advertising, software or firmware updates, system quality or security checks, etc.

Furthermore, the wagering game system architecture 200 can be implemented as software, hardware, any combination thereof, or other forms of embodiments not listed. For example, any of the network components (e.g., the wagering game machines, servers, etc.) can include hardware and machine-readable storage media including instructions for performing the operations described herein. Machine-readable storage media includes any mechanism stores information in a form readable by a machine (e.g., a wagering game machine, computer, etc.). For example, tangible machine-readable storage media includes read only memory (ROM), random access memory (RAM), magnetic disk storage media, optical storage media, flash memory machines, etc. In some embodiments, machine-readable signal media includes any media suitable for transmitting software over a network.

### Example Operations

This section describes operations associated with some embodiments. In the discussion below, some flow diagrams are described with reference to block diagrams presented herein. However, in some embodiments, the operations can be performed by logic not described in the block diagrams.

In certain embodiments, the operations can be performed by executing instructions residing on machine-readable storage media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform more or less than all the operations shown in any flow diagram.

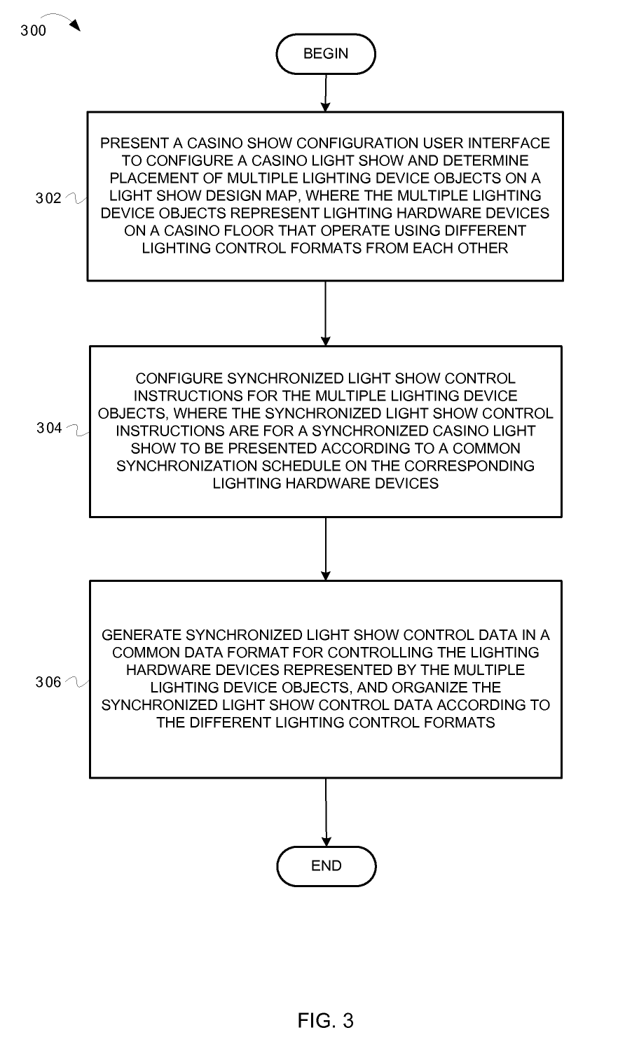

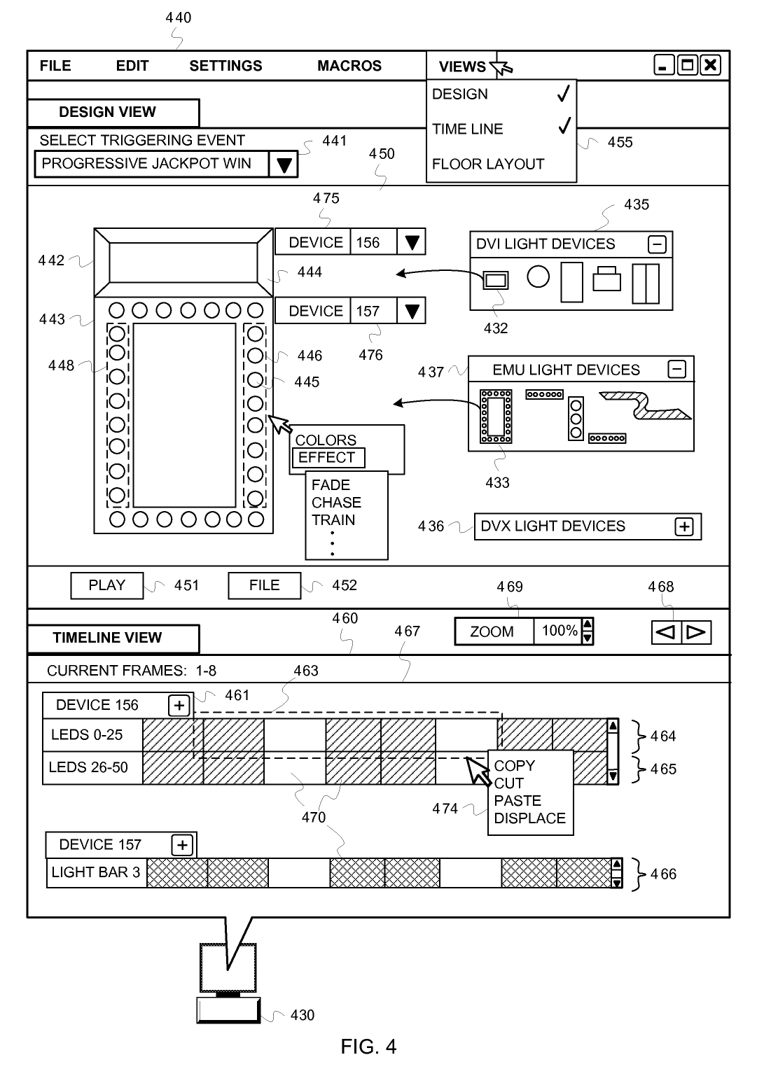

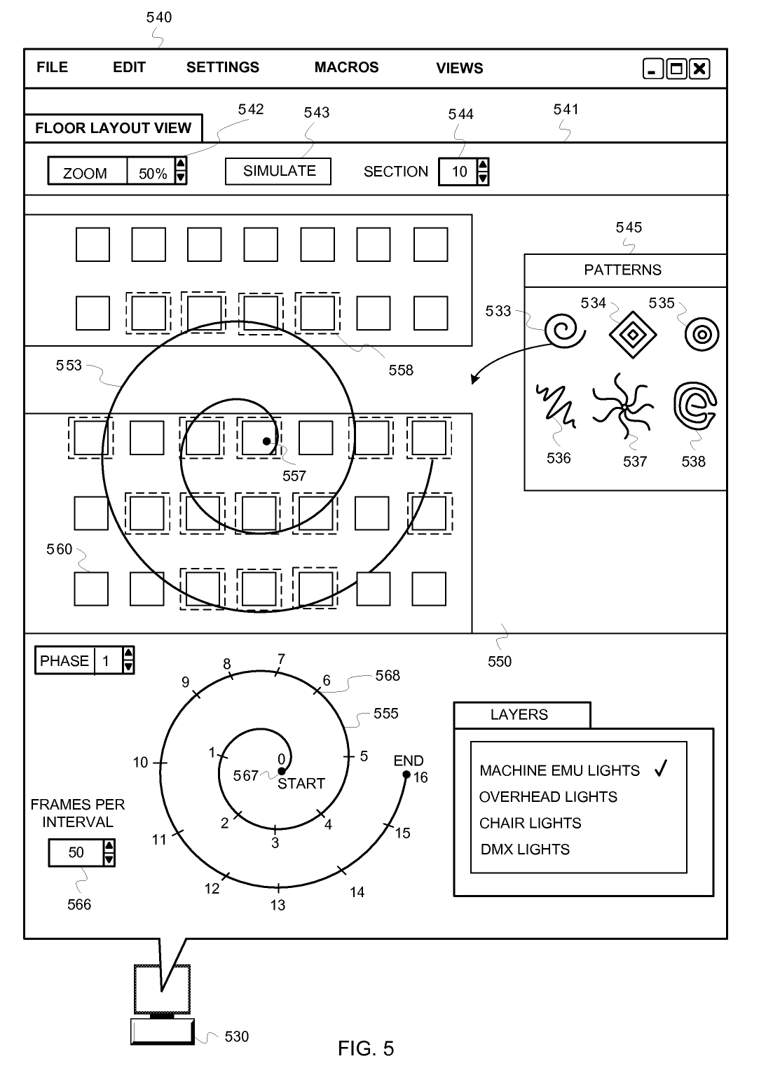

FIG. 3 is a flow diagram (“flow”) 300 illustrating configuring a light show using configurable lighting device objects and configurable timelines, according to some embodiments. FIGS. 4, and 5 are conceptual diagrams that help illustrate the flow of FIG. 3, according to some embodiments. This description will present FIG. 3 in concert with FIGS. 4 and 5 and also FIG. 1. In FIG. 3, the flow 300 begins at processing block 302, where a wagering game system (“system”) presents a casino show configuration user interface (“configuration interface”) to configure a casino light show and determines placement of multiple lighting device objects on a light show design map, where the multiple lighting device objects represent lighting hardware devices on a casino floor that operate using different lighting control formats from each other. The configuration interface can present the lighting device objects on the light show design map. The lighting device objects may include light emitting diode (LED) display objects, light-bulb or lamp fixture objects, laser fixture objects, neon fixture objects, fluorescent lighting fixture objects, high-definition plasma display objects, high-definition LED display objects, organic light emitting diode (OLED) device objects, stereoscopic display objects, liquid crystal display (LCD) objects, LCD projection lamp objects, strobe-light fixture objects, spotlight fixture objects, etc. The lighting device objects correlate to the lighting hardware devices, or in other words, the lighting device objects correlate to real-world lighting devices (e.g., LED displays, light-bulb fixtures, fluorescent lighting fixtures, neon lighting fixtures, laser light fixtures, neon light fixtures, LCD displays, LCD projection lamps, high-definition televisions, OLED devices, stereoscopic displays, strobe light fixtures, spotlight fixtures, etc.) on the casino floor that present light effects. The lighting device objects can include configuration objects that can be used to configure light effect characteristics associated with the lighting hardware devices. Examples of light effect characteristics can include lighting hardware device rotation activities, signal production activities, timing control activities, light production activities, etc. For example, the light effect characteristics can relate to light source elements on the lighting hardware devices that present the light effect characteristics. The system can present light source objects (e.g., LED objects, light bulb objects, lamp objects, etc.), on the light show design map, which correlate to the light source elements (e.g., LED pixels, light bulbs, etc.) on the lighting hardware devices. The light source elements produce light properties and characteristics (i.e., photon intensity, light colors, ultraviolet properties, blinking patterns, etc.) for the light effects generated by the lighting hardware devices. The configuration interface can provide controls and functionality on the light show design map for configuring the presentation of light effects on the lighting device objects, and constituent light source objects, according to a light show timeline.

FIG. 4 illustrates an example of a casino show configuration user interface (“configuration interface”) 440 with a light show design map 450. In FIG. 4, a casino show configuration server (“show configuration server”) 430 presents the configuration interface 440 that a casino operator, or other user, can use to configure casino shows (e.g., light shows). For example, the configuration interface 440 can present dropdown menus, panels, and other controls that present configuration options and settings. For instance, the configuration interface 440 can present a views dropdown 455 that indicates a design view, a timeline view, and a floor layout view. FIG. 4 depicts the design view and the timeline view. FIG. 5, further below, illustrates an example of the floor layout view. Still referring to FIG. 4, however, the configuration interface 440 includes lighting device consoles 435, 436, and 437. A first lighting device console 435 presents lighting device objects for a first lighting control format type (e.g., a DVI light control format). An operator can drag a first lighting device object image 432 onto a design space (i.e., onto the light show design map 450). The first lighting device object image 432 can expand to be a first large-scale, configurable lighting device object (“first lighting device object”) 442. The first lighting device object 442 can represent a first real-world lighting device, or hardware lighting device, that carries a first unique identifier number 475. The first unique identifier number 475 can correlate to the first hardware lighting device and can uniquely identify the first hardware lighting device amongst other hardware lighting devices that are positioned throughout a casino floor. The first lighting device object 442 can include one or more configuration objects (e.g., light source objects), such as a light bar object 444. The light bar object 444 correlates with a light-bar lamp attached to the first hardware lighting device that correlates to the first lighting device object 442. The first hardware lighting device, and associated light-bar lamp(s), require the first lighting control format type specified in the first lighting device console 435.

In addition, a second lighting device console 437 presents lighting device objects for a second lighting control format type (i.e., the EMU light control format). An operator can drag a second lighting device object image 433 onto the light show design map 450. The second lighting device object image 433 can expand to be a second large-scale, configurable lighting device object (“second lighting device object”) 443. The second lighting device object 443 can represent a second hardware lighting device that carries a second unique identifier number 476. The second unique identifier number 476 can correlate to the second hardware lighting device and can uniquely identify the second hardware lighting device amongst other lighting hardware devices that are positioned throughout a casino floor. The second lighting device object 443 can include one or more configuration objects (e.g., light source objects), such as LED objects 445, which represent individual LEDs (e.g., an LED pixel) or groups of individual LEDs (e.g., an LED color cluster). The LED objects 445 correlate with LEDs attached to the second hardware lighting device, which correlates to the second lighting device object 443. The second hardware lighting device, and associated LEDs, require the second lighting control format type specified in the second lighting device console 437.

The operator can select any portion of the first lighting device object 442 or the second lighting device object 443 and control (e.g., manipulate, alter, define, etc.) any configuration settings (e.g., attributes, activities, properties, etc.) for the first lighting device object 442 or the second lighting device object 443 and/or their respective lighting objects, such as the light bar object 444 or the LED objects 445. For instance, an operator can select a row of the LED objects 445, resulting in a first selection box 446. The operator can right click on the first selection box 446 and select a lighting attribute (e.g., light color, light effect or pattern, etc.) to apply to any of the LED objects 445 within the first selection box 446. The operator can also copy the first selection box 446 and paste any of the settings associated with the LED objects 445 that are within the first selection box 446 onto a second selection box 448 indicated by the operator. Thus, an operator can copy and paste configuration settings for large selections of the LED objects 445. In other embodiments, the operator can drag and drop the first selection box 446 onto the second selection box 448 or to other locations of the configuration interface 440. The configuration interface 440 can provide drag-and-drop functionality between settings, libraries, layouts, timelines, etc. Further, the configuration interface 440 can have multiple shows open at the same time for easy transfer of lighting patterns, object selections, timelines selections, etc. from one show to another. In addition, the configuration interface 440 can save show settings with group identifiers explicitly relating multiple shows to similar themes, hardware groups, venues, etc.

In some embodiments, the configuration interface 440 is accessible to a player, such as via a web interface. The player can use the configuration interface 440 to configure or customize some features of a light show (e.g., changing colors of certain lights, selecting from a dropdown of pre-configured light shows, selecting a favorite song which is synchronized to a particular light show, etc.). Furthermore, in some embodiments, the configuration interface 440 can include controls that import existing media (e.g., images, video, sounds, etc.) for reference or direct application to light show configurations (e.g., dragging a movie onto a light fixture to automatically sample movie colors onto the lights, dragging an image file into an editor to automatically generate a custom fixture from the image, etc.). Furthermore, the configuration interface 440 can provide controls and settings to generate recursive and interconnected shows. For example, an operator can use the configuration interface 440 to generate a set of shows for a complex fixture. The operator can use the configuration interface 440 to generate a master control show that references and visualizes playback of the individual previously generated shows from the set of shows.

Returning momentarily to FIG. 3, the flow 300 continues at processing block 304, where the system configures synchronized light show control instructions for the multiple lighting device objects, where the synchronized light show control instructions are for a synchronized casino light show to be presented according to a common synchronization schedule on the corresponding lighting hardware devices. For example, returning to FIG. 4, the configuration interface 440 can present a timeline console 460 that includes controls for configuring settings for a shared light show schedule or common light show timeline (“timeline”) 467 that can apply to multiple groups of lighting device objects simultaneously, such as for the first lighting device object 442 and the second lighting device object 443. The timeline console 460 can present one or more timeline portions, or timeline sequences 464, 465, and 466. The timeline sequences 464, 465, 466 include presentation frames for part of a light show that correlates with the configuration objects, such as the light source objects (e.g., the light bar object 444 and the LED objects 445) for the first lighting device object 442 and the second lighting device object 443. The number of presentation frames displayed may be limited to a number of presentation frames that fit on a display of the configuration interface 440 at one time. The number of presentation frames displayed on the timeline sequences 464, 465, 466, can be changed based on a timeline scale size (e.g., as indicated by the timeline scale control 469 for the timeline 467). The timeline console 460 can also present a scroll control 468 for scrolling from one portion of the timeline 467 to another. Other features not shown can include a search function to search for specific configurations of the timeline 467 or a jump function that jumps to specific sections of the timeline 467. For each presentation frame of the timeline sequences 464, 465, 466, the operator can configure timeline settings and light effect settings, such as time durations, light intensities, colors, motion, etc. of light patterns that occur for any portion of the first lighting device object 442 and the second lighting device object 443 that are part of the casino light show (e.g. that have been selected, highlighted, activated, previously configured, etc., such as the light bar object 444 and the LED objects 445). For instance, a frame set 461 can relate to LED pixels for the first lighting device object 442 during eight frames of the light show. The operator can select multiple frames of one of the timeline sequences 464, 465 and/or 466, (e.g., from timeline sequence 464) resulting in a selection box 463. The operator can right click on the selection box 463 resulting in a dropdown menu 474 to copy, cut, paste, displace, etc. the selected frames in the selection box 463 to any of the other timeline sequence 465 and/or 466. In some embodiments, the operator can drag and drop the selection box 463 to any of the other timeline sequence 465 and/or 466. Further, the timeline sequences 464, 465, 466 can present light effect objects 470, which are representations of light effect characteristics. In other words, the light effect objects 470 are represented by different shading patterns on the presentation frames. The different shading patterns represent different light effect characteristics (e.g., different colors, intensities, etc.) for light effects that occur at each frame during the timeline 467. The operator can manipulate the light effect characteristics by manipulating the light effect objects 470.

The operator can also select a triggering event from an event dropdown 441. The triggering event can be a wagering game event that occurs on a wagering game machine to which the first and second hardware lighting devices are associated. The operator can also select a play button 451 that instructs the show configuration server 430 to plays a simulation, or preview, of the light show design according to the configuration settings for the first lighting device object 442 and the second lighting device object 443 and the settings in the timeline console 460. When an operator selects the play button 451, the show configuration server 430 can present a preview of the synchronized casino light show on the light show design map 450. In other words, the show configuration server 430 can present a simultaneous preview of light effects on the light source objects (e.g., the light bar object 444 and the LED objects 445) as they would appear during actual run-time of the casino light show. The show configuration server 430 can also present a preview of other light effect characteristics and activities, such as lighting device rotation and movement, initiation of fog effects, vibrations in wagering game machine chairs, etc., that are configured via the show configuration server 430.

In some embodiments, the show configuration server 430 can reference priority rules during design and use them before, or during, the presentation of the preview to indicate priority conflicts. For example, the show configuration server 430 can reference priority rules that determine player preferences or player input to avoid conflicts. In another example, the show configuration server 430 can generate a global database of shows and can assign priorities to the shows in the database. The show configuration server 430 can refer to the assigned priorities to determine conflicts. The show configuration server 430 can also present possible conflict views, during preview of the synchronized casino light show, based on specific gaming events. For example, an operator can change the option in the event dropdown 441 to a higher priority event, and the show configuration server 430 can determine specific priority conflicts that occur to the show presentation within the light show design map 450 based on the selection of the higher priority event. The show configuration server 430 can then automatically reconfigure the show to compensate for the higher event conflicts or present compensating actions from which the operator can select. In some embodiments, the show configuration server 430 can also present previews of the light show from different angles of the casino floor (e.g., a player level view, an overhead view, a bank angle view, etc.).

Further, the configuration interface 440 can present a save button 452, which an operator can select to save into a light show configuration file the configuration settings for the first lighting device object 442 and the second lighting device object 443 (or any other configured objects on the light show design map 450 or listed on the timeline 467). The show configuration server 430 can store the light show configuration file in a common data format, but can distinguish different lighting control formats for the first lighting device object 442 and the second lighting device object 443, as described above in FIG. 1.

In addition, the configuration interface 440 can utilize modular editing panes that are adapted to handle new types of data, forms of visualization, desired interface widgets, etc. Thus, the configuration interface 440 can adapt to new light hardware, lighting control formats, venue options, etc.

FIG. 5 illustrates another example of configuring light shows using a casino show configuration user interface (“configuration interface”) 540. In FIG. 5, a casino show configuration server (“show configuration server”) 530 presents the configuration interface 540. The configuration interface 540 presents a floor layout view 541 for configuring casino shows, such as light shows, that run in conjunction with gaming events. The floor layout view 541 can include a light show pattern console 545. The light show pattern console 545 can include graphical shapes or designs that indicate pre-set light presentation timing patterns (“light timing patterns”) that follow a light show timeline (“timeline”) 555 for a casino light show presentation. The graphical shapes or designs may be referred to herein as light timing pattern graphics. Examples of light timing pattern graphics can include, but are not limited to, a swirling circular pattern graphic 533, a concentric diamond pattern graphic 534, a concentric circle pattern graphic 535, a snake pattern graphic 536, a radiating pattern graphic 537, a random pattern graphic 538, or any other customized or variable patterns (e.g., patterns that look like a casino logo, spatial growth patterns, parameterizable spatial mathematical function patterns, wave patterns, generic polygon patterns, patterns that represent numerical sequences, chaotic patterns, scatter patterns, patterns that look like objects, patterns that look like a player's avatar or picture, etc.). An operator can select a light timing pattern graphic, for instance, the swirling circular pattern graphic 533, from the light show pattern console 545, and drop the swirling circular pattern graphic 533 onto a casino floor layout map 550. The casino floor layout map 550 presents a plurality of lighting device objects 560 that represent lighting hardware devices on a casino floor. When dropped on the casino floor layout map 550, the swirling circular pattern graphic 533 can expand in shape and present a timing pattern graphic line 553 over at least a portion of the lighting device objects 560.

The timeline 555 mimics the shape of the timing pattern graphic line 553 and can be presented separately as a series of timeline interval points 568 that correlate with selected lighting device objects 558. The show configuration server 530 can assign some of the lighting device objects 560 (i.e., selected lighting device objects 558 indicated by selection boxes), to the timing pattern graphic line 553 when any portion of the timing pattern graphic line 553 comes within a specified distance (e.g., within 0.25 inches) of the plurality of lighting device objects 560. The specified distance can be set by default and an operator can also change the specified distance. The specified distance can also vary based on other factors, such as a type of triggering event, a type of show, a scale of the casino floor layout map 550, a scale of the size of the timing pattern graphic line 553 compared to the size of the light device objects 560, etc. One of the plurality of lighting device objects 560 can represent an origin point 557 for the light timing pattern defined by the timeline 555. For instance, an origin point can coincide with a wagering game machine that experiences a triggering event (e.g., a winning event) for the light show associated with the timing pattern graphic line 553. The timeline 555 can include the timeline interval points 568 that the operator can configure on different points along the timeline 555. The operator can also configure a time period for the timeline 555 using a timing control 566 that defines a number of frames per timeline interval point. The timeline 555 represents the timing pattern graphic line 553 in shape and function, and defines a light timing pattern for a light show that is presented using the timing pattern graphic line 553. Thus, the timeline 555 and the timing pattern graphic line 553 are coupled, and in some embodiments, can be displayed as the same screen object, or in other embodiments, like that shown in FIG. 5, they can be separated to be configured separately (i.e., the timing pattern graphic line 553 configures physical positioning of light effects while the timeline 555 configures the timing of the light effects). In some embodiments, the show configuration server 530 can automatically configure, or assign, the timelines interval points 568 to correspond, on the timeline 555, with the selected lighting device objects 558 that touch, or are within the specified distance to, the timing pattern graphic line 553. The timeline interval points 568 represent light effect trigger points in time that initiate light effects on lighting hardware devices associated with the selected lighting device objects 558 that were assigned to the timing pattern graphic line 553. The light effects are part of a lighting sequence for a light show that begins at the origin point 557 and extends incrementally from trigger point to trigger point through the timing pattern graphic line 553. One timeline point 567 of the timeline interval points 568 can correspond to the origin point 557 for the timing pattern graphic line 553. In some embodiments, a light show may include multiple timing pattern graphic lines, for example, the radiating pattern graphic 537 has multiple timing pattern graphic lines with a single origin point. Where there are multiple timing pattern graphic lines, the lighting sequence can follow multiple timing pattern graphic lines simultaneously or according to a staggered pattern (e.g., a first timing pattern graphic line begins playing light effects, a second timing pattern graphic line adjacent to the first timing pattern graphic line begins playing 2 seconds after the first, and so forth until all timing pattern graphic lines have played the show). Each of the timing pattern graphic lines can also be configured to play different light effects according to different timelines.

In some embodiments, timeline interval points and/or timing pattern graphic lines can be spread across different parts of a casino floor. An operator can select a zoom control 542 that zooms in and out of the casino floor layout map 550 or a location control 544 that selects different sections that represent an actual casino floor. An operator can select multiple light timing pattern graphics from the light show pattern console 545 and drop them on different parts of the casino floor layout map 550 that correlate with the different sections of the casino floor. In some embodiments, the show configuration server 530 can also present previews of the light show as seen from different angles of the casino floor according to a setting indicated in the location control 544.

An operator can configure light effects on the selected lighting device objects 558 in different ways. For example, in some embodiments, the light timing pattern graphics from the light show pattern console 545 can have pre-set timing patterns and configured show effects. In some embodiments, an operator can select a pre-configured casino light show from a dropdown and associate the timing pattern graphic line 553 with the pre-configured light show. In some embodiments, an operator can configure light effects on the selected lighting device objects 558 by expanding a view of each of the selected lighting device objects 558 and configuring individual light source elements associated with each of the selected lighting device objects 558, similarly as described in FIG. 4. In some embodiments, the operator can configure the timing pattern graphic line 553 and drag it back to the light show pattern console 545, or to another location, as a saved, customized version.

In some embodiments, an operator can move or manipulate the floor layout view 541, such as via a function that allows an operator to drag the casino floor layout map 550 around with a mouse cursor. In some embodiments, the casino floor layout map 550 may, in some embodiments, represent an actual geographical location of a specific casino floor. However, in other embodiments, the casino floor layout map 550 does not necessarily have to represent a portion of an actual casino floor (e.g., does not have to directly relate to specific geographic coordinates on the casino floor) but instead may present a representative view of lighting device objects 560 on a scaled version of a sample casino floor section so that an operator can scale the characteristics (e.g., size, position, direction, etc.) of timing graphic pattern lines relative to the lighting device objects 560 regardless of the actual geographic location of a specific casino floor section.

In some embodiments, the configuration interface 540 can provide a simulation control 543 to present a simulation of a light show configured within the configuration interface 540. In some embodiments, the configuration interface 540 can also provide layering functionality, including the ability to position presentation layers of timing pattern graphics. The different presentation layers of timing pattern graphics can overlap on the casino floor layout map 550 and can run simultaneously or contemporaneously (e.g., staggered, cascading, etc.). The presentation layers can represent different levels of lighting device objects (e.g., one layer controls machine level lighting, a second layer controls overhead level lighting, etc.). Some, or all, presentation layers can be linked and run, or present, the same light show simultaneously, others can be linked to run different shows or different parts of a show but on a shared overall timeline, and yet some presentation layers can be linked to run contemporaneously while other presentation layers function independently of the linked presentation layers. Some presentation layers can represent different lighting objects that work according to different lighting control formats as described further above (e.g., one layer shows DVI type lighting, another shows DMX type lighting, etc.).

The show configuration server 530 can send light show data to a network device that controls light shows, such as the show control server 140 shown in FIG. 1. The light show data can include configured information for the timing pattern graphic line 553 and the timeline 555 in the form of the control instructions 170, which the show controls server 140 can receive. The show control server 140 can detect occurrence of the gaming event on a wagering game machine on the casino floor and associate the origin point 557 on the timing pattern graphic line 553 with a corresponding location of the wagering game machine on the casino floor. The show control server 140 can determine a scale for the specified distance of the selected lighting device objects 558 to the timing pattern graphic line 553 and associate the selected lighting device objects 558 with any lighting devices on the casino floor that fall on the timing pattern graphic lines 553 according to the scale. The show control server 140 can then present the pre-configured casino light show on the associated lighting devices according to the timeline 555 using the corresponding location of the wagering game machine as the origin point, or originating timeline interval point, for the timeline 555. For example, the show control server 140 can present an initial light effect at a first lighting device located at the origin point of the wagering game machine, and then present additional light effects at additional lighting device locations at additional location points that correspond with the timeline interval points on the timeline 555.

Returning momentarily to FIG. 3, the flow 300 continues at processing block 306, where the system generates synchronized light show control data in a common data format for controlling the lighting hardware devices represented by the multiple lighting device objects, and organizes the synchronized light show control data according to the different lighting control formats. For example, in FIG. 1, the show configuration server 130 can generate the control instructions 170 in a common output format. The control instructions 170 include lighting control instructions for the lighting devices 152, 153 and 154. The lighting devices 152, 153 and 154 require lighting instructions in one or more different lighting control formats. The show configuration server 130 can organize (e.g., classify, notate, separate, segregate, convert, etc.) the control instructions 170 to indicate a lighting control format for each of the lighting device objects 132, 133, and 134 configured via the configuration interface 131. For example, the show configuration server 130 can store the control instructions 170 in one or more configuration files that represent each of the lighting device objects 132, 133, and 134 and/or each of the different lighting control formats. In other words, the show configuration server 130 can store the control instructions 170 in multiple configuration files each having data in the common format, one configuration file for each lighting control format or one configuration file for each device. However, the show configuration file can also generate a single configuration file and segregate, or specify, the control instructions 170 using lighting control format type identifiers and/or device identifiers within the single configuration file. For example, the show configuration server 130 can embed format markers within the control instructions 170 to indicate specific lighting control formats for light control instructions that relate to the different lighting device objects 132, 133, 134. In other words, for the display device object 132, the show configuration server 130 knows that the display device object 132 requires the DVI input format, and thus embeds a DVI format marker 171 for control instructions associated with the display device object 132. Likewise, the show configuration server 130 also embeds a DMX format marker 172 and an EMU format marker 173 for control instructions associated, respectively, with the spot light device object 133 and the emotive lighting device object 134. The control instructions 170 may thereafter also be referred to as organized (e.g., classified, notated, segregated, separated, etc.) control instructions 170. The show configuration server 130 can send the organized control instructions 170 to the hardware specific conversion module 147 to convert into hardware specific lighting control instructions. As stated previously, the hardware specific conversion module 147 can be part of the show configuration server 130 or separate from the show configuration server 130.

It should be noted that in some embodiments the show configuration server 130 in FIG. 1 is similar to the show configuration server 430 in FIG. 4 or the show configuration server 530 in FIG. 5. Therefore, in some embodiments, the show configuration server 130 may represent either the show configuration server 430 or the show configuration server 530.

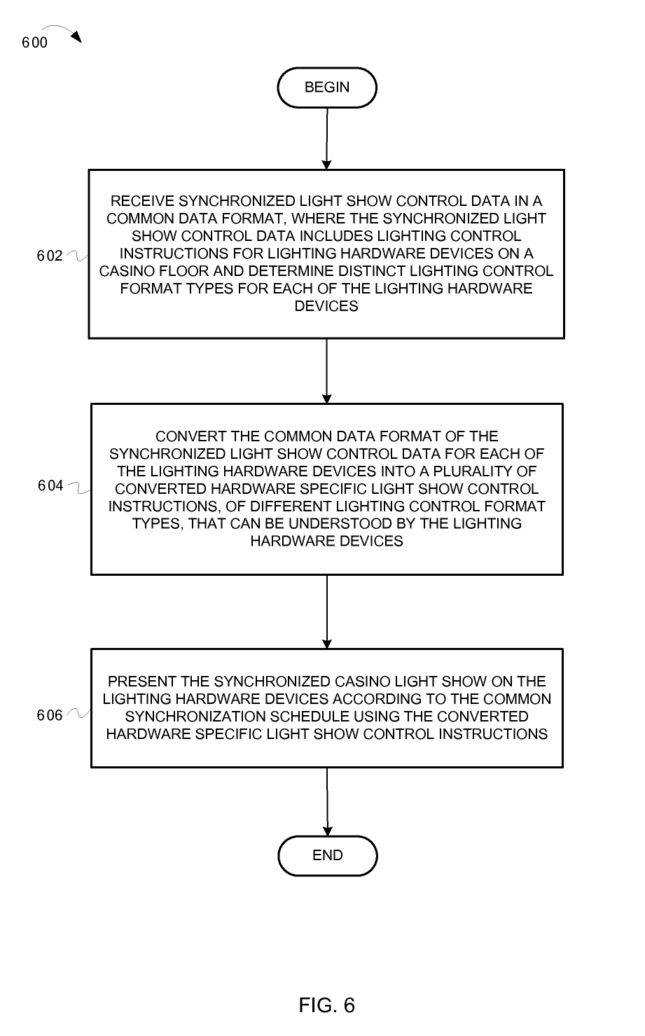

FIG. 6 is a flow diagram (“flow”) 600 illustrating receiving show control data in a common data format, converting the common data to hardware specific lighting control instructions for lighting hardware devices that utilize different lighting control formats, and controlling the lighting hardware devices using converted lighting control instructions, according to some embodiments. This description will present FIG. 6 in concert with FIG. 1. In FIG. 6, the flow 600 begins at processing block 602, where a wagering game system (“system”) receives synchronized light show control data in a common data format, where the synchronized light show control data includes lighting control instructions for lighting hardware devices on a casino floor and determines distinct lighting control format types for each of the lighting hardware devices. For instance, returning to FIG. 1, the hardware specific conversion module 147 can receive the control instructions 170. The hardware specific conversion module 147 can parse and manipulate the control instructions 170 based on lighting control format type and/or device identifiers within the configuration file. The lighting devices 152, 153 and 154 require lighting instructions in different lighting control formats, and the hardware specific conversion module 147 can separate and convert the control instructions 170 from the common data format to the required lighting control formats for the lighting devices 152, 153 and 154. For instance, the hardware specific conversion module 147 can determine, from the control instructions 170, hardware identifiers for the lighting devices 152, 153 and 154 and determine lighting control formats associated with the hardware identifiers (e.g., by looking at lighting control format identifiers embedded in the control instructions 170 that correlate to the hardware identifiers, by using a network service or network data source to determine lighting control formats for the hardware identifiers, by referring to hardware specification files stored on a network computer that specify correlate hardware identifiers and associated lighting control formats for the correlate hardware identifiers, etc.).

The flow 600 continues at processing block 604, where the system converts the common data format of the synchronized light show control data for each of the lighting hardware devices into a plurality of converted hardware specific light show control instructions, of different lighting control format types, that can be understood by the lighting hardware devices. For example, referring again to FIG. 1, the hardware specific conversion module 147 can receive the control instructions 170, and separate the control instructions 170 that relate to each individual presentation device (e.g., separates the control instructions 170 into the set of DVI light control instructions 141, the set of DMX light control instructions 142, and the set of EMU light control instructions 143). The hardware specific conversion module 147 can convert the common format (e.g., the XML format) of the control instructions 170 to the individual lighting control formats (e.g., DVI, DMX, and EMU formats) required respectively by the display device 152, the spot light device 153, and the emotive lighting device 154. The hardware specific conversion module 147 can provide the converted control instructions (e.g., the set of DVI light control instructions 141, the set of DMX light control instructions 142, and the set of EMU light control instructions 143) to the show control server 140. The show control server 140 can use the converted control instructions to control the lighting devices (e.g., the display device 152, the spot light device 153, and the emotive lighting device 154).

The flow 600 continues at processing block 606, where the system presents the synchronized casino light show on the lighting hardware devices according to the common synchronization schedule using the converted hardware specific light show control instructions. For example, referring again to FIG. 1, in some embodiments, the hardware specific conversion module 147 can provide the converted control instructions to the casino show controller 146, which can the coordinate the transmission of the converted control instructions, or coordinate sequences of converted control instructions, to the lighting devices 152, 153 and 154 for sequences of light effects that are part of one or more light show timelines specified in the control instructions 170. The casino show controller 146 can determine, from the control instructions 170, hardware identifiers for the lighting devices 152, 153 and 154, and send the converted control instructions to network addresses associated with the hardware identifiers.

The casino show controller 146 can also coordinate the synchronization of the show light effects across banks of devices. Further, in some embodiments, the system 100 can also generate re-addressable control instructions that can be re-addressed and targeted at different presentation devices that meet the same hardware specifications (e.g., that use the same lighting control formats) as the lighting devices 152, 153, and 154. In other words, other lighting devices in other parts of a casino may also utilize the same lighting control formats as the lighting devices 152, 153, and 154. The system 100 can thus readdress the control instructions 170, including converted versions of the control instructions 170, to the other lighting devices to run the same light show associated with the control instructions 170.

In some embodiments, the casino show controller 146 can recognize and integrate player owned devices (“player device”) into a light show presentation. For example, the casino show controller 146 can query a player device (e.g., query via Bluetooth) to determine a required control format that the player device uses. The player device can respond to the query and indicate its required control format(s) for different presentation elements of the device (e.g., display control formats, sound control formats, vibration control formats, etc.). The casino show controller 146 can then generate presentation instructions for the required control format(s), which the player device can present on presentation elements associated with the player device (e.g., present a portion of the light show on the player device's screen, cause the player device to vibrate according to a timeline for light effects associated with the player's current wagering game machine, etc.). The casino show controller 146 can instruct the hardware specific conversion module 147 to convert the light show instructions 170 into instructions that comply with the required control format(s). In some embodiments, the hardware specific conversion module 147 can convert a lighting instruction to a presentation function for the player device that is different from light presentation. For example, the hardware specific conversion module 147 can convert a lighting instruction into a vibration instruction or sound instruction.

### Additional Example Operating Environments

This section describes example operating environments, systems and networks, and presents structural aspects of some embodiments.

### Wagering Game Machine Architecture

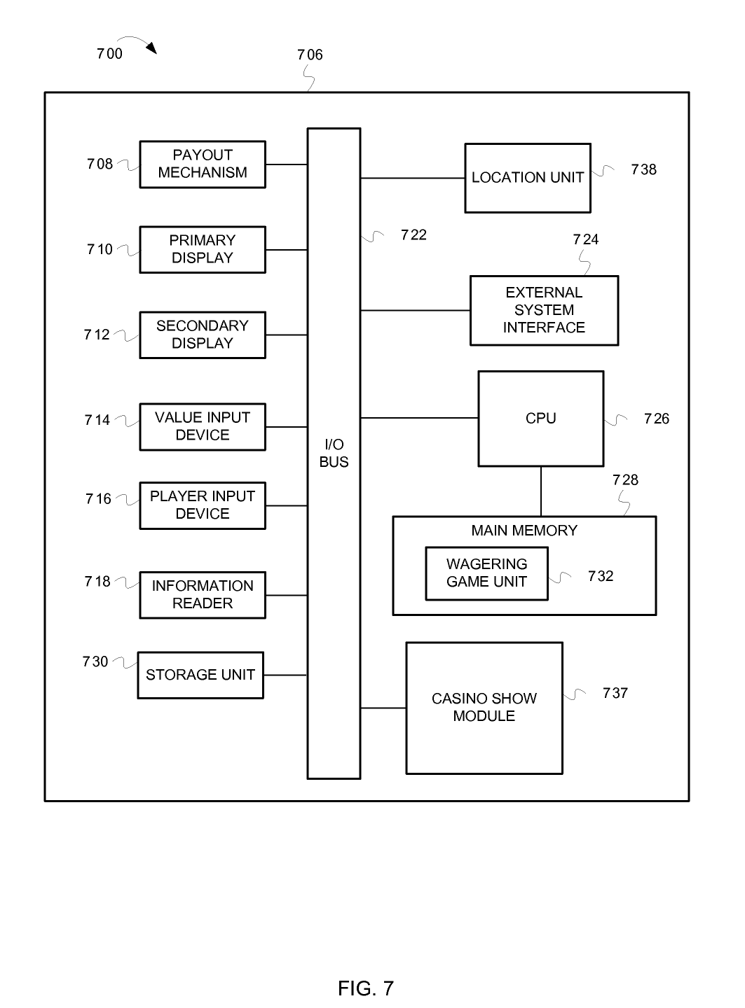

FIG. 7 is a conceptual diagram that illustrates an example of a wagering game machine architecture 700, according to some embodiments. In FIG. 7, the wagering game machine architecture 700 includes a wagering game machine 706, which includes a central processing unit (CPU) 726 connected to main memory 728. The CPU 726 can include any suitable processor, such as an Intel® Pentium processor, Intel® Core 2 Duo processor, AMD Opteron™ processor, or UltraSPARC processor. The main memory 728 includes a wagering game unit 732. In some embodiments, the wagering game unit 732 can present wagering games, such as video poker, video black jack, video slots, video lottery, reel slots, etc., in whole or part.

The CPU 726 is also connected to an input/output (“I/O”) bus 722, which can include any suitable bus technologies, such as an AGTL+ frontside bus and a PCI backside bus. The I/O bus 722 is connected to a payout mechanism 708, primary display 710, secondary display 712, value input device 714, player input device 716, information reader 718, and storage unit 730. The player input device 716 can include the value input device 714 to the extent the player input device 716 is used to place wagers. The I/O bus 722 is also connected to an external system interface 724, which is connected to external systems (e.g., wagering game networks). The external system interface 724 can include logic for exchanging information over wired and wireless networks (e.g., 802.11g transceiver, Bluetooth transceiver, Ethernet transceiver, etc.)

The I/O bus 722 is also connected to a location unit 738. The location unit 738 can create player information that indicates the wagering game machine's location/movements in a casino. In some embodiments, the location unit 738 includes a global positioning system (GPS) receiver that can determine the wagering game machine's location using GPS satellites. In other embodiments, the location unit 738 can include a radio frequency identification (RFID) tag that can determine the wagering game machine's location using RFID readers positioned throughout a casino. Some embodiments can use GPS receiver and RFID tags in combination, while other embodiments can use other suitable methods for determining the wagering game machine's location. Although not shown in FIG. 7, in some embodiments, the location unit 738 is not connected to the I/O bus 722.

In some embodiments, the wagering game machine 706 can include additional peripheral devices and/or more than one of each component shown in FIG. 7. For example, in some embodiments, the wagering game machine 706 can include multiple external system interfaces 724 and/or multiple CPUs 726. In some embodiments, any of the components can be integrated or subdivided.

In some embodiments, the wagering game machine 706 includes a casino show module 737. The casino show module 737 can process communications, commands, or other information, where the processing can configure or control casino multimedia content shows.

Furthermore, any component of the wagering game machine 706 can include hardware, firmware, and/or machine-readable storage media including instructions for performing the operations described herein.

### Mobile Wagering Game Machine

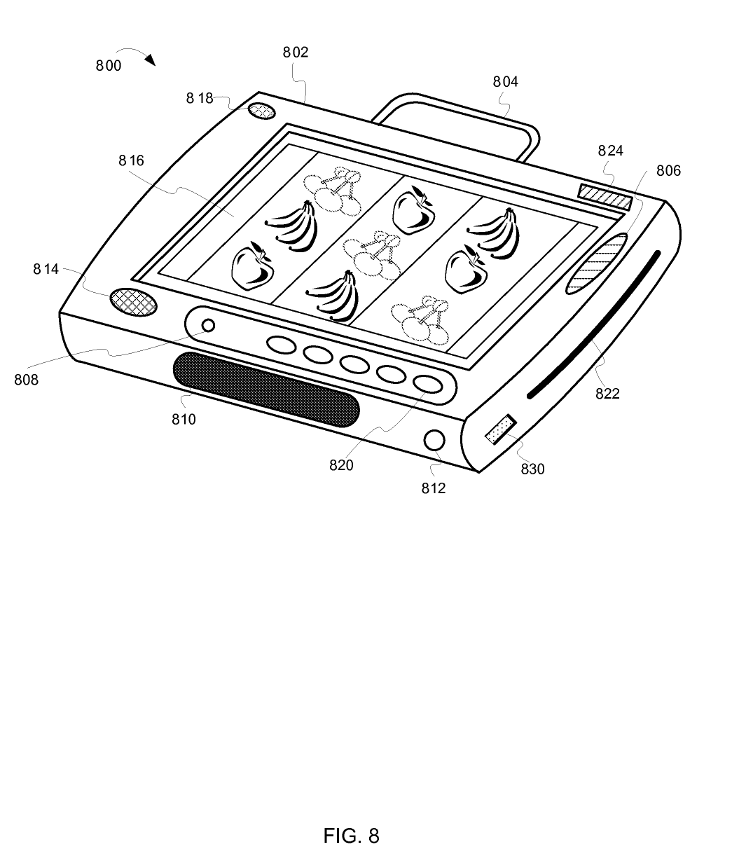

FIG. 8 is a conceptual diagram that illustrates an example of a mobile wagering game machine 800, according to some embodiments. In FIG. 8, the mobile wagering game machine 800 includes a housing 802 for containing internal hardware and/or software such as that described above vis-à-vis FIG. 7. In some embodiments, the housing has a form factor similar to a tablet PC, while other embodiments have different form factors. For example, the mobile wagering game machine 800 can exhibit smaller form factors, similar to those associated with personal digital assistants. In some embodiments, a handle 804 is attached to the housing 802. Additionally, the housing can store a foldout stand 810, which can hold the mobile wagering game machine 800 upright or semi-upright on a table or other flat surface.

The mobile wagering game machine 800 includes several input/output devices. In particular, the mobile wagering game machine 800 includes buttons 820, audio jack 808, speaker 814, display 816, biometric device 806, wireless transmission devices (e.g., wireless communication units 812 and 824), microphone 818, and card reader 822. Additionally, the mobile wagering game machine can include tilt, orientation, ambient light, or other environmental sensors.

In some embodiments, the mobile wagering game machine 800 uses the biometric device 806 for authenticating players, whereas it uses the display 816 and the speaker 814 for presenting wagering game results and other information (e.g., credits, progressive jackpots, etc.). The mobile wagering game machine 800 can also present audio through the audio jack 808 or through a wireless link such as Bluetooth.

In some embodiments, the wireless communication unit 812 can include infrared wireless communications technology for receiving wagering game content while docked in a wager gaming station. The wireless communication unit 824 can include an 802.11G transceiver for connecting to and exchanging information with wireless access points. The wireless communication unit 824 can include a Bluetooth transceiver for exchanging information with other Bluetooth enabled devices.

In some embodiments, the mobile wagering game machine 800 is constructed from damage resistant materials, such as polymer plastics. Portions of the mobile wagering game machine 800 can be constructed from non-porous plastics, which exhibit antimicrobial qualities. Also, the mobile wagering game machine 800 can be liquid resistant for easy cleaning and sanitization.

In some embodiments, the mobile wagering game machine 800 can also include an input/output (“I/O”) port 830 for connecting directly to another device, such as to a peripheral device, a secondary mobile machine, etc. Furthermore, any component of the mobile wagering game machine 800 can include hardware, firmware, and/or machine-readable storage media including instructions for performing the operations described herein.

### Wagering Game Machine

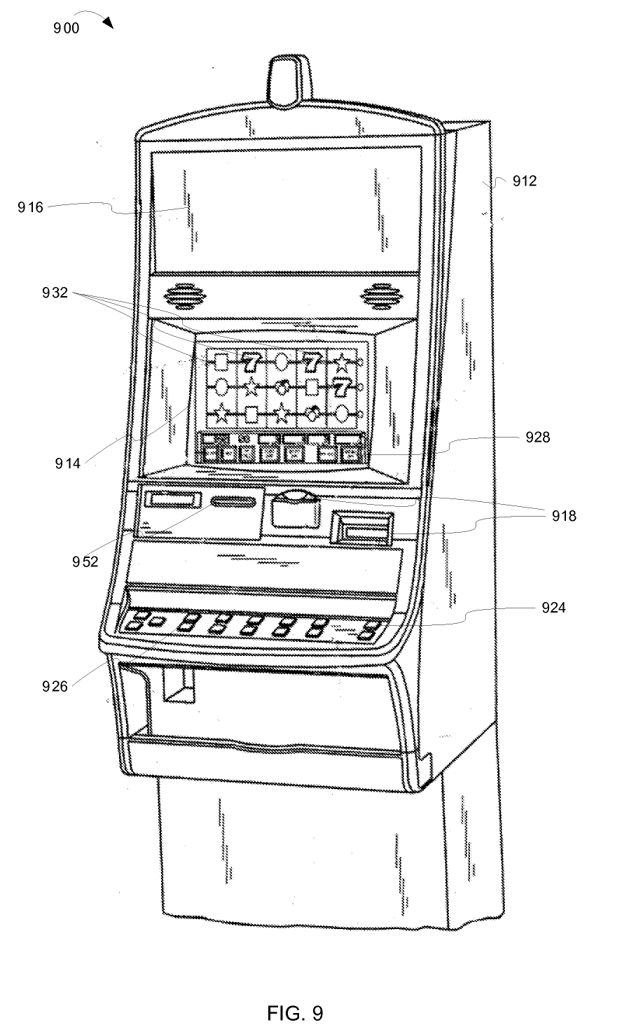

FIG. 9 is a conceptual diagram that illustrates an example of a wagering game machine 900, according to some embodiments. Referring to FIG. 9, the wagering game machine 900 can be used in gaming establishments, such as casinos. According to some embodiments, the wagering game machine 900 can be any type of wagering game machine and can have varying structures and methods of operation. For example, the wagering game machine 900 can be an electromechanical wagering game machine configured to play mechanical slots, or it can be an electronic wagering game machine configured to play video casino games, such as blackjack, slots, keno, poker, blackjack, roulette, etc.

The wagering game machine 900 comprises a housing 912 and includes input devices, including value input devices 918 and a player input device 924. For output, the wagering game machine 900 includes a primary display 914 for displaying information about a basic wagering game. The primary display 914 can also display information about a bonus wagering game and a progressive wagering game. The wagering game machine 900 also includes a secondary display 916 for displaying wagering game events, wagering game outcomes, and/or signage information. While some components of the wagering game machine 900 are described herein, numerous other elements can exist and can be used in any number or combination to create varying forms of the wagering game machine 900.

The value input devices 918 can take any suitable form and can be located on the front of the housing 912. The value input devices 918 can receive currency and/or credits inserted by a player. The value input devices 918 can include coin acceptors for receiving coin currency and bill acceptors for receiving paper currency. Furthermore, the value input devices 918 can include ticket readers or barcode scanners for reading information stored on vouchers, cards, or other tangible portable storage devices. The vouchers or cards can authorize access to central accounts, which can transfer money to the wagering game machine 900.

The player input device 924 comprises a plurality of push buttons on a button panel 926 for operating the wagering game machine 900. In addition, or alternatively, the player input device 924 can comprise a touch screen 928 mounted over the primary display 914 and/or secondary display 916.

The various components of the wagering game machine 900 can be connected directly to, or contained within, the housing 912. Alternatively, some of the wagering game machine's components can be located outside of the housing 912, while being communicatively coupled with the wagering game machine 900 using any suitable wired or wireless communication technology.

The operation of the basic wagering game can be displayed to the player on the primary display 914. The primary display 914 can also display a bonus game associated with the basic wagering game. The primary display 914 can include a cathode ray tube (CRT), a high resolution liquid crystal display (LCD), a plasma display, light emitting diodes (LEDs), or any other type of display suitable for use in the wagering game machine 900. Alternatively, the primary display 914 can include a number of mechanical reels to display the outcome. In FIG. 9, the wagering game machine 900 is an “upright” version in which the primary display 914 is oriented vertically relative to the player. Alternatively, the wagering game machine can be a “slant-top” version in which the primary display 914 is slanted at about a thirty-degree angle toward the player of the wagering game machine 900. In yet another embodiment, the wagering game machine 900 can exhibit any suitable form factor, such as a free standing model, bar top model, mobile handheld model, or workstation console model.

A player begins playing a basic wagering game by making a wager via the value input device 918. The player can initiate play by using the player input device's buttons or touch screen 928. The basic game can include arranging a plurality of symbols along a pay line 932, which indicates one or more outcomes of the basic game. Such outcomes can be randomly selected in response to player input. At least one of the outcomes, which can include any variation or combination of symbols, can trigger a bonus game.

In some embodiments, the wagering game machine 900 can also include an information reader 952, which can include a card reader, ticket reader, bar code scanner, RFID transceiver, or computer readable storage medium interface. In some embodiments, the information reader 952 can be used to award complimentary services, restore game assets, track player habits, etc.

The described embodiments may be provided as a computer program product, or software, that may include a machine-readable storage medium having stored thereon instructions, which may be used to program a computer system (or other electronic device(s)) to perform a process according to embodiments(s), whether presently described or not, because every conceivable variation is not enumerated herein. A machine-readable storage medium includes any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, some embodiments may include machine-readable signal media, which is embodied in an electrical, optical, acoustical or other form of propagated signal (e.g., carrier waves, infrared signals, digital signals, etc.).

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments, which are defined only by the appended claims. Each of the embodiments described herein are contemplated as falling within the inventive subject matter, which is set forth in the following claims.

1. A computer-implemented method comprising:
presenting a light show design map on a user interface;
presenting lighting device objects on the light show design map, wherein the lighting device objects correlate to lighting hardware devices in a casino that present light effects using different lighting control formats, and wherein the lighting device objects are assigned to the different lighting control formats;
configuring the light effects for the lighting device objects according to user input via the user interface;
generating light show control data in a common data format for the lighting device objects; and
converting the light show control data from the common data format to hardware specific lighting control instructions that comply with the different lighting control formats.

2. The computer-implemented method of claim 1 further comprising:
providing the hardware specific lighting control instructions to a light show control device that is capable of presenting the light effects on the lighting hardware devices using the hardware specific lighting control instructions.

3. The computer-implemented method of claim 1, wherein configuring the light effects comprises:
determining a user selection of multiple groups of the lighting devices objects; and
simultaneously configuring the light effects for the multiple groups of the lighting devices.

4. The computer-implemented method of claim 1, wherein presenting the lighting device objects on the light show design map comprises:
presenting separate sets of the lighting device objects, wherein the separate sets of the lighting device objects represent sets of lighting devices that utilize the different lighting control formats;
determining user selections of multiple ones of the lighting device objects from the separate sets of the lighting device objects;
presenting the multiple ones of the lighting device objects on the light show design map, wherein the multiple ones of the lighting device objects include light source objects that present light effect previews on the light show design map, and wherein the light source objects correlate with light source elements on the lighting hardware devices that produce light for the light effects; and
configuring the light source objects with light effect settings according to the user input.

5. The computer-implemented method of claim 1, wherein the different lighting control formats include one or more of a proprietary emotive lighting data format, a digital visual interface format, and a DMX lighting format, and wherein the common data format comprises an XML data format.

6. The computer-implemented method of claim 1 further comprising presenting the user interface via a web-browser.

7. The computer-implemented method of claim 1 further comprising:
generating format type identifiers that identify the different lighting control formats that are associated with each of the lighting device objects; and
embedding the format type identifiers in one or more files of lighting control instructions for groups of lighting control instructions that pertain to the different lighting control formats.

8. One or more machine-readable storage media having instructions stored thereon, which when executed by a set of one or more processors causes the set of one or more processors to perform operations comprising:
receiving synchronized light show control data in a common data format, wherein the synchronized light show control data includes lighting control instructions for presenting light effects for a casino light show on both a first lighting hardware device and a second lighting hardware device in a casino, wherein the first lighting hardware device operates using a first lighting control format and the second lighting hardware device operates using a second lighting control format, wherein the second lighting control format is different from the first lighting control format;
converting the common data format of the synchronized light show control data to a first set of converted lighting control instructions that comply with the first lighting control format for the first lighting hardware device, and a second set of converted lighting control instructions that comply with the second lighting control format for the second lighting hardware device;
controlling a first set of light effects for the casino light show on the first lighting hardware device using the first set of converted lighting control instructions; and
controlling a second set of light effects for the casino light show on the second lighting hardware device using the second set of converted lighting control instructions.

9. The one or more machine-readable storage media of claim 8, said operations further comprising:
determining, from the synchronized light show control data, hardware identifiers for the first lighting hardware device and the second lighting hardware device;
referring to hardware specification files for the hardware identifiers stored on a network computer;
searching through the hardware specification files to find correlates of the hardware identifiers; and
ascertaining the first lighting control format and the second lighting control format specified in the hardware specification files associated with the correlates of the hardware identifiers.

10. The one or more machine-readable storage media of claim 8, said operations further comprising:
determining, from the synchronized light show control data, hardware identifiers for the first lighting hardware device and the second lighting hardware device;
determining lighting control format identifiers embedded in the synchronized light show control data that correlate with the hardware identifiers; and
ascertaining the first lighting control format and the second lighting control format using the lighting control format identifiers.

11. The one or more machine-readable storage media of claim 8, said operations further comprising:
detecting a common light show presentation schedule stored in the synchronized light show control data; and
presenting the casino light show on the first lighting hardware device and the second lighting hardware device according to the common light show presentation schedule.

12. The one or more machine-readable storage media of claim 11, wherein said operation of presenting the light show on the first lighting hardware device and the second lighting hardware device according to the common light show presentation schedule includes operations further comprising:
detecting, from the synchronized light show control data, a first hardware identifier for the first lighting hardware device and a second hardware identifier for the second lighting hardware device;
detecting a first casino network address associated with the first hardware identifier and a second casino network address associated with the second hardware identifier;
providing a first sequence of instructions, from the first set of lighting control instructions, to the first casino network address for the first lighting hardware device, wherein the first sequence of instructions follows a first timeline, specified in the common light show presentation schedule, for the first lighting hardware device; and
providing a second sequence of instructions, from the second set of lighting control instructions, to the second casino network address for the second lighting hardware device, wherein the second sequence of instructions follows a second timeline, specified in the common light show presentation schedule, for the second lighting hardware device.

13. The one or more machine-readable storage media of claim 11, said operations further comprising:
determining at least one required presentation format for at least one presentation element on a player owned device;
converting one or more of the first set of lighting control instructions and the second set of lighting control instructions to a converted set of presentation instructions for the at least one required presentation format; and
providing the converted set of presentation instructions to the player owned device to present on the at least one presentation element of the player owned device according to the common light show presentation schedule.

14. The one or more machine-readable storage media of claim 8, wherein the lighting hardware devices are one or more of a light emitting diode display, a light-bulb fixture, a laser light fixture, a neon light fixture, a liquid crystal display, an organic light emitting diode device, a stereoscopic display, a high-definition television, a fluorescent lighting fixture, a liquid crystal display projection lamp, a strobe light fixture, and a spot light fixture.

15. A system comprising:
a casino content show configuration device configured to
present a casino floor layout map on a user interface,
present lighting device objects on the casino floor layout map, wherein the lighting device objects represent lighting hardware devices in a casino,
present a plurality of light timing pattern graphics on the user interface, wherein the plurality of light timing pattern graphics represent pre-set presentation patterns for a casino light show,
select, via user input, one light timing pattern graphic from the plurality of light timing pattern graphics, wherein the one light timing pattern graphic includes one or more timing pattern graphic lines that present the casino light show along the one or more timing pattern graphic lines according to a light show timeline,
position, via the user input, the light timing pattern graphic on the casino floor layout map over at least a portion of the lighting device objects,
select a number of the lighting device objects that are within a specified distance to the one or more timing pattern graphic lines,
associate the number of the lighting device objects with the one or more timing pattern graphic lines, and
configure each of the number of the lighting device objects with light show effects for the casino light show; and
a casino content show control device configured to
detect occurrence of a gaming event on a wagering game machine in the casino, wherein the gaming event triggers the presentation of the casino light show,
associate lighting hardware devices with the timing pattern graphic lines in a way that correlates with the number of the lighting device objects that are within the specified distance to the one or more timing pattern graphic lines, and
present the casino light show on the lighting hardware devices according to the light show timeline using a location of the wagering game machine as a starting point for the casino light show.

16. The system of claim 15, wherein the plurality of light timing pattern graphics comprise one or more of a swirling circular pattern, a concentric diamond pattern, a concentric circle pattern, a snake pattern, a radiating pattern, a random pattern, a spatial growth pattern, a parameterizable spatial mathematical function pattern, a wave pattern, a generic polygon pattern, a pattern that represents numerical sequences, a chaotic pattern, a scatter pattern, a casino logo image, and a player avatar image.

17. The system of claim 15, wherein the casino content show configuration device is further configured to configure presentation layers of the casino floor layout map that represent specific lighting device objects on the casino floor that work according to different lighting formats.

18. The system of claim 15, wherein the specified distance is based on one or more of an operator preference, a type of triggering event, a type of show, a scale associated with the casino floor layout map, and a scale of a size of the timing pattern graphic compared to a size of the lighting device objects.

19. The system of claim 15, wherein the casino content show control device is further configured to
determine a position of an origin point for the one light timing pattern graphic on at least one of the lighting device objects on the casino floor layout map,
associate the origin point for the at least one of the lighting device objects on the casino floor layout map with the location of the wagering game machine, and
use the corresponding location of the wagering game machine as a beginning point for the casino light show.

20. An apparatus comprising:
a casino show module configured to
present a casino floor layout map on a user interface,
present lighting device objects on the casino floor layout map, wherein the lighting device objects represent lighting hardware devices in a casino,
present a plurality of light timing pattern graphics on the casino show configuration user interface, wherein the plurality of light timing pattern graphics represent pre-set presentation patterns for a casino light show,
select, via user input, one light timing pattern graphic from the plurality of light timing pattern graphics, wherein the one light timing pattern graphic includes one or more timing pattern graphic lines that present the casino light show along the one or more timing pattern graphic lines according to a lightshow timeline,
position, via the user input, the light timing pattern graphic on the casino floor layout map over at least a portion of the lighting device objects,
select a number of the lighting device objects that are within a specified distance to the one or more timing pattern graphic lines,
associate the number of the lighting device objects with the one or more timing pattern graphic lines,
assign a plurality of timeline interval points on the light show timeline that correlate with the number of lighting device objects associated with the one or more timing pattern graphic lines,
configure each of the number of the lighting device objects with light show effects for the casino light show, and
configure the light show effects to present at each of the plurality of timeline interval points according to the lightshow timeline.

21. The apparatus of claim 20, wherein the casino show module is further configured to
determine location points on the one or more timing pattern graphic lines that are within the specified distance to the one or more timing pattern graphic lines, and
assign the plurality of timeline interval points to positions on the timeline that correlate with the location points on the one or more timing pattern graphic lines, wherein the timeline interval points represent light effect trigger points in time that initiate light effects on the lighting hardware devices associated with the number of the lighting device objects assigned to the one or more timing pattern graphic lines

22. The apparatus of claim 20, wherein the casino show module is further configured to
determine a plurality of timing pattern graphic lines associated with the one light timing pattern graphic, and
configure each of the plurality of timing pattern graphic lines with separate light effects that run according to different timelines for the casino light show.

23. An apparatus comprising:
means for presenting a light show design map on a user interface;
means for presenting lighting device objects on the light show design map, wherein the lighting device objects correlate to lighting hardware devices that present light effects using different lighting control formats, wherein the lighting device objects are assigned to the different lighting control formats;
means for presenting configuration objects on the lighting device objects, wherein the configuration objects are configurable for light effect characteristics, and wherein the configuration objects correlate with lighting device elements on the lighting hardware devices that present the light effect characteristics;
means for presenting light show timelines associated with the configuration objects, wherein the light show timelines follow a common time schedule for a casino light show;
means for presenting light effect objects on the light show timelines per time frame, which light effect objects represent the light effect characteristics over time; and
means for configuring the representations of light effects on the light show timelines according to user input.

24. The apparatus of claim 23 further comprising means for presenting a light show preview of the light effects, according to the common time schedule for the casino light show, on one or more of light source objects on the light show design map and on the lighting hardware devices.

25. The apparatus of claim 24 further comprising means for presenting the light show preview from multiple views of the casino floor layout map which represent multiple views of a casino floor.

26. The apparatus of claim 24 further comprising:
means for presenting a control to select one of a plurality of gaming events that triggers presentation of the casino light show;
means for determining a user selection of one of the plurality of the gaming events; and
means for presenting conflict views during the light show preview according to light show priorities related to the one of the plurality of the gaming events.
